(19) United States
(12) Patent Application Publication
(10) Pub. No.: US 2015/0091736 A1
(43) Pub. Date: Apr. 2, 2015

(54) FLAG THAT PLAYS SOUNDS WITH DETECTED MOTION

(71) Applicant: Evergreen Enterprises of Virginia, LLC, Richmond, VA (US)

(72) Inventors: Timothy A. Lamm, Midlothian, VA (US); ShouHen Zha, Ningbo City (CN)

(73) Assignee: EVERGREEN ENTERPRISES OF VIRGINIA, LLC, Richmond, VA (US)

(21) Appl. No.: 14/499,521

(22) Filed: Sep. 29, 2014

Related U.S. Application Data
(60) Provisional application No. 61/884,195, filed on Sep. 30, 2013.

(51) Int. Cl. G08B 3/10; H04W 4/00; G09F 17/00

(52) U.S. Cl. CPC G08B 3/10; G09F 17/00; H04W 4/008
USPC 340/692

(57) ABSTRACT

A flag that includes a motion detector or timer is described. When the flag detects motion or after a certain length of time, the flag will play a noise, such as a wind chime, sounds of nature, or a song, such as a national anthem, or organization song. The flag includes a motion detector or timer, a battery pack, circuitry to direct the playing of the noise, and a speaker. Alternatively, the flag includes a Bluetooth-enabled receiving device that will play a noise when a signal is received from a Bluetooth-enabled transmitting device.

### CROSS-REFERENCE TO RELATED APPLICATION

This application claims the benefit of U.S. Provisional Application No. 61/884,195, filed Sep. 30, 2013, the contents of which are incorporated herein by reference.

### FIELD OF THE INVENTION

The field of the invention generally relates to decorative flags. More specifically, the invention relates to a decorative flag that plays sounds with detected motion.

### BACKGROUND OF THE INVENTION

The sale and display of flags is prevalent in many locales. Flags may come in various shapes and sizes and are often displayed outside buildings or homes. It is also desirable to hear sounds, such as wind chimes, songs, or the like when the wind blows. To fill this need, many consumers hang wind chimes outside their homes or other buildings.

### SUMMARY OF THE INVENTION

The invention relates to various exemplary embodiments, including articles such as flags that include motion detectors and that play sounds upon detected motion.

These and other features and advantages of the invention are described below with reference to the accompanying drawings.

### BRIEF DESCRIPTION OF THE DRAWINGS

FIG. 1 is a view of a flag according to the present invention.

FIG. 2 is a cutaway view of the flag as shown in FIG. 1.

FIG. 3 is a cutaway view of an alternative implementation of the flag as shown in FIG. 1.

FIGS. 4-5 are views of a printed circuit board used in the flag as shown in FIG. 3.

FIG. 6 is a cutaway view of an alternative implementation of the flag as shown in FIG. 1.

FIG. 7 is a cutaway view of an alternative implementation of the flag as shown in FIG. 6.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Before the present invention is described in further detail, it is to be understood that the invention is not limited to the particular embodiments described, and as such may, of course, vary. It is also to be understood that the terminology used herein is for the purpose of describing particular embodiments only, and is not intended to be limiting, since the scope of the present invention will be limited only by the appended claims.

A number of materials are identified as suitable for various aspects of the invention. These materials are to be treated as exemplary and are not intended to limit the scope of the claims. Although any methods and materials similar or equivalent to those described herein can also be used in the practice or testing of the present invention, a limited number of the exemplary methods and materials are described herein.

It must be noted that as used herein and in the appended claims, the singular forms “a”, “an”, and “the” include plural referents unless the context clearly dictates otherwise.

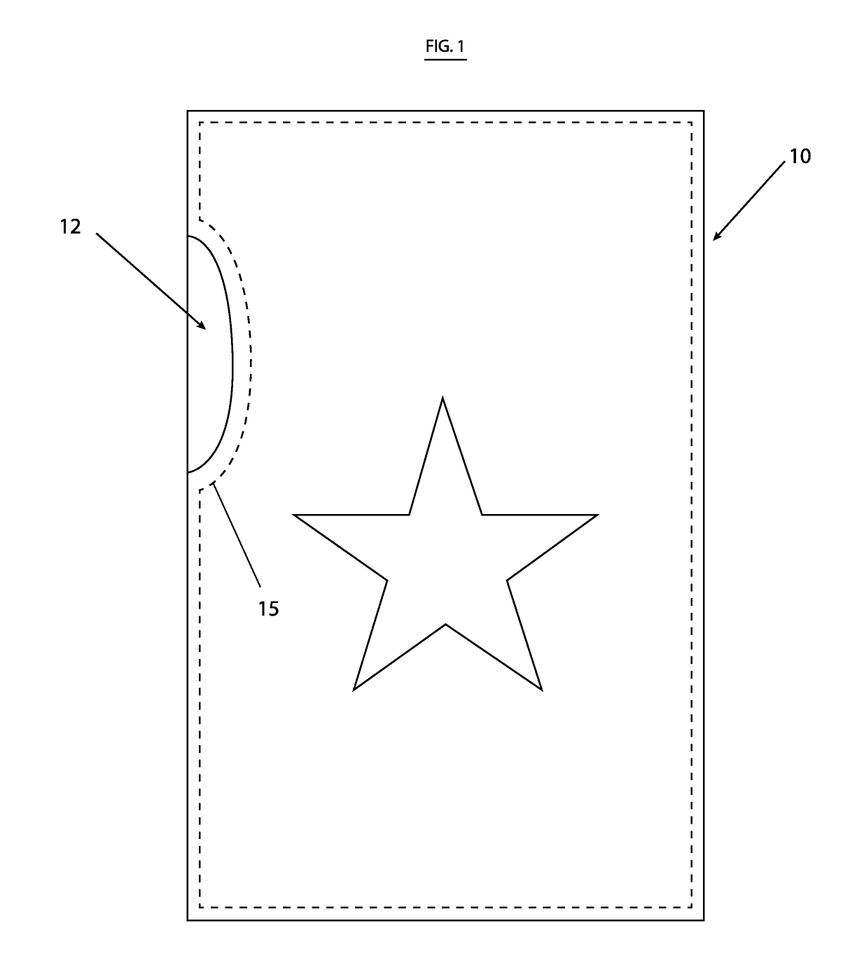

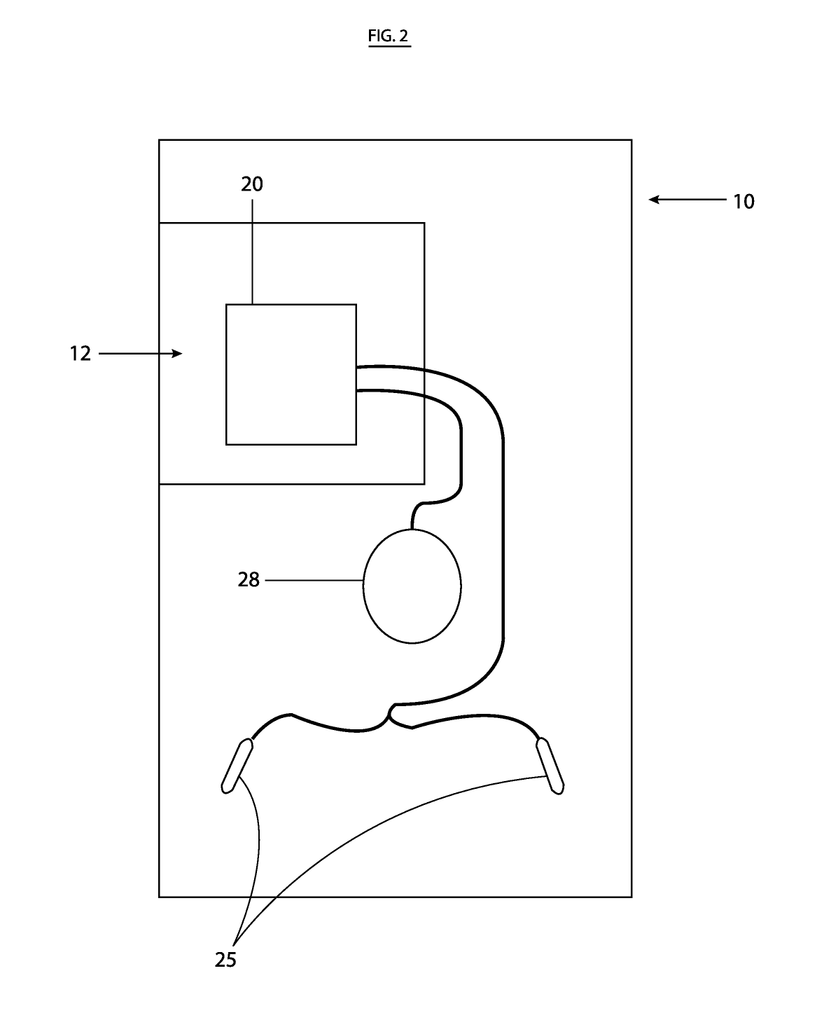

Referring to FIGS. 1-2, the invention is shown implemented as a flag 10. The flag 10 could be formed of any material typically used for flags, including natural and synthetic materials, that would permit it to flap or move in the wind or breeze. The flag 10 includes an inner pocket 12 sewn into one of the side seams 15 of the flag 10. Inside the inner pocket 12 is a battery pack with circuitry 20 and an on/off switch to create a wind chime effect. The circuitry 20 connects to a set of sensors 25 secured further down the flag 10. The sensors 25 detect movement (e.g., waving in the wind) of the flag 10. When triggered by the sensor 25, the circuitry 20 causes a wind chime noise to play out of the speaker 28, also fastened inside the flag 10. The result is that the flag 10 creates a wind chime noise when it is moved, such as when it is flapping in the wind.

The flag 10 can be implemented as a garden flag sized flag, but may also be implemented as smaller or larger flags. In such a case, the battery pack with circuitry 20, sensors 25, and speaker 28 would be scaled up or down as necessary for the particular application.

While it is contemplated that the flag will play sounds resembling traditional wind chimes when blowing in the wind, the particular sounds are not so limited. The circuitry 20 could be programmed to play virtually any sound, including, but not limited to, sounds of nature, alarms, songs, or the like. For example, the flag 10 could be designed as a pennant or banner for a particular sports team, in which case the circuitry 20 could be programmed to play the fight song for that particular team. Alternatively, the flag could be designed to be the flag 10 of a particular country or state, in which case the circuitry 20 could be programmed to play the national or state anthem of the country or state. Particular organizations could implement the flag 10 to include the organization's logo and a song or jingle associated with that organization.

An alternative embodiment of this product includes timer or clock circuitry that allows the flag to play a pre-recorded sound (e.g., wind chime noises) at pre-determined times, such as on the hour, every hour. This alternative embodiment could therefore be used to signal each hour by playing wind chimes sounds, clock sounds (e.g., ticking or chiming to sound on the hour), or other songs or sounds.

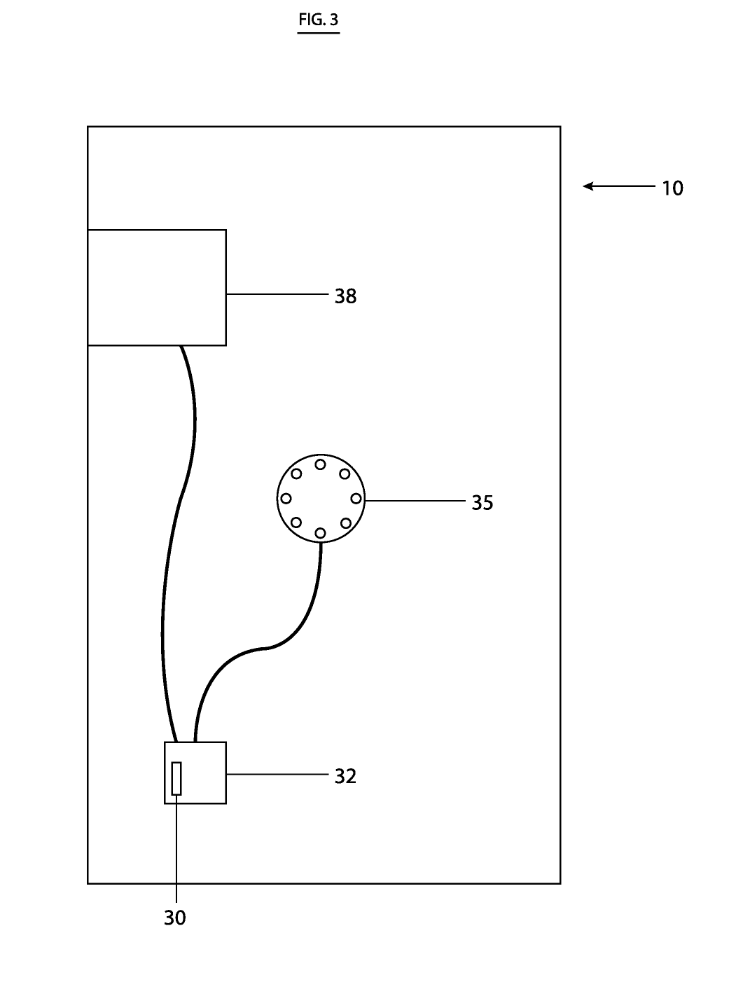

FIG. 3 shows an implementation of the flag 10 with a single motion detector 30. In this implementation, the motion detector 30 is a vibration sensor switch, such as SW-18010P, although other types of motion detectors may also be used. The motion detector 30 is attached to a printed circuit board 32 that includes a sound chip. Wires connect the circuit board 32 to speaker 35 that permits the sounds to be played aloud, and battery package 38.

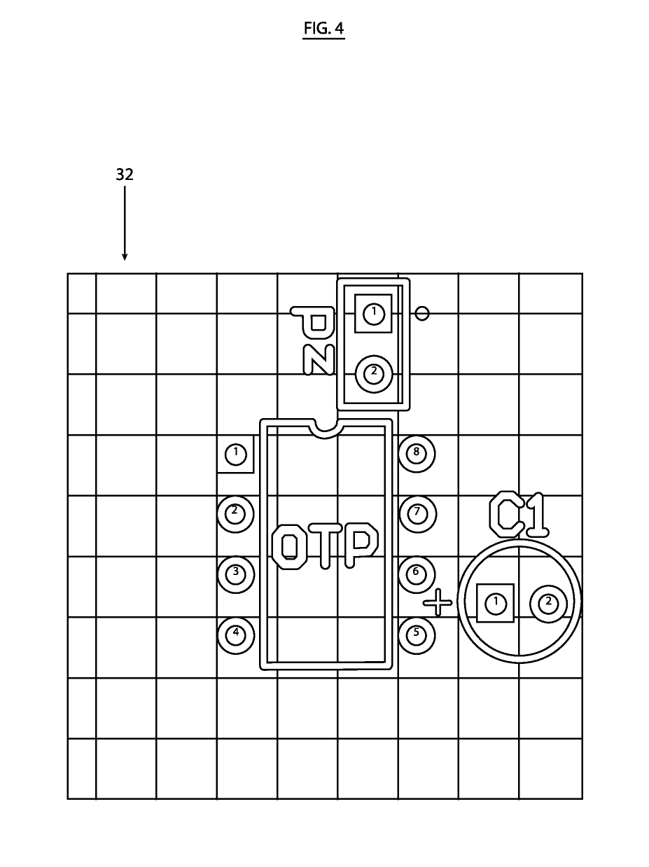

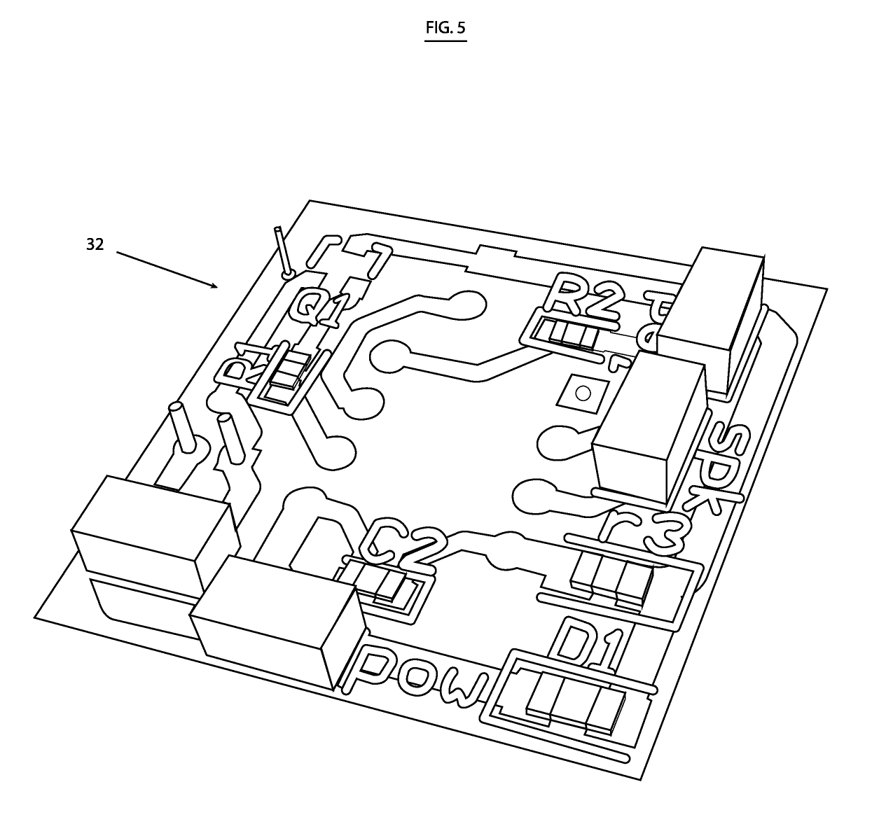

FIGS. 4-5 show close up views of the printed circuit board 32 that is described above. These circuit boards 32 can also be implemented to include lighting chips that will permit LED or fiber optic lights to be included in the flag 10. This will permit not only the sound, but also a light to be activated upon detected motion.

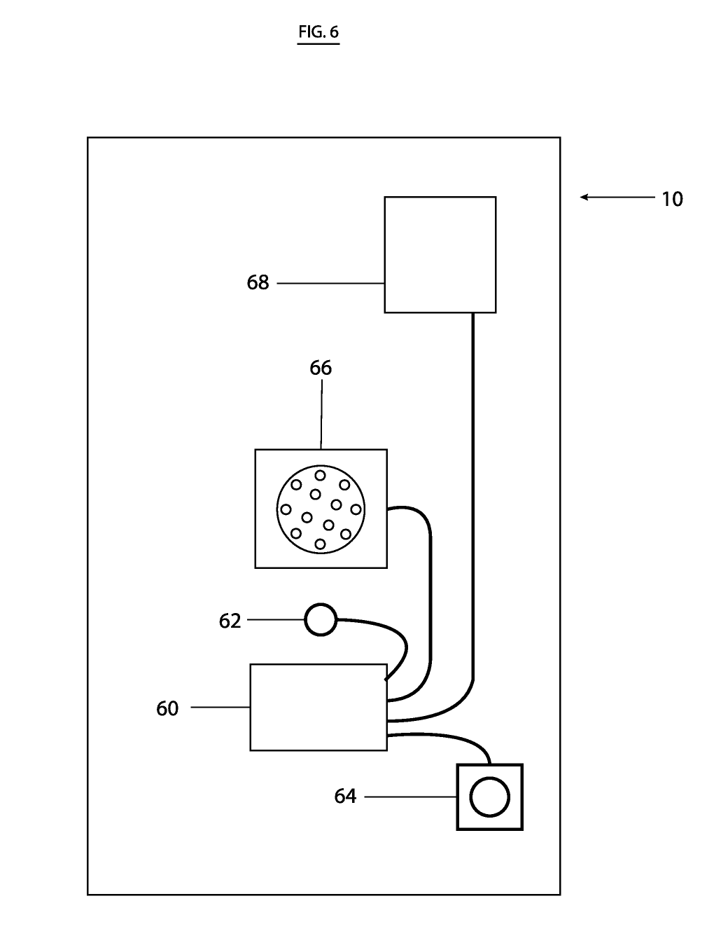

FIG. 6 shows an implementation of flag 10 with a Bluetooth pack 60. The Bluetooth pack 60 includes a Bluetooth LED 62 and an on-off switch 64. Wires connect the Bluetooth pack 60 to a sound box 66 and a battery pack 68. In use, the flag 10 plays music or other pre-recorded or live audio data when paired with a mobile device or other Bluetooth-enabled device equipped with such data or equipped with technology to transmit/receive such data.

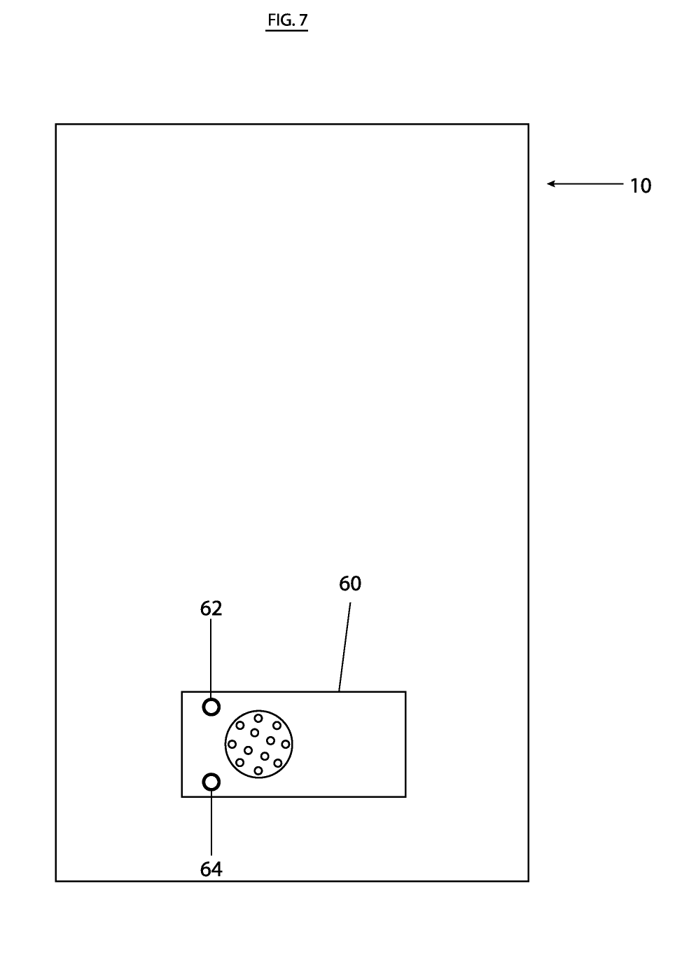

FIG. 7 shows an implementation of flag 10 with a Bluetooth sound box 60 that includes the Bluetooth LED 62, on-off switch 64, and the battery pack in a waterproof box located within the flag 10. In this implementation, the sound box is a Bluetooth sound box and does not require a separate sound box to play audio data.

Numeric values and ranges are provided for various aspects of the implementations described above. These values and ranges are to be treated as examples only and are not intended to limit the scope of the claims.

While the invention has been described in conjunction with specific exemplary implementations, it is evident to those skilled in the art that many alternatives, modifications, and variations will be apparent in light of the foregoing description. Accordingly, the invention is intended to embrace all such alternatives, modifications, and variations that fall within the scope and spirit of the appended claims.

What is claimed is:

1. An article comprising:
a flag formed of a natural or synthetic material, and
an inner pocket within the flag, the inner pocket including:
at least one motion sensor that generates a signal when motion is detected;
a speaker;
a battery; and
circuitry that includes a sound chip that plays a sound when the signal is received from the at least one motion sensor.

2. The article of claim 1, wherein the motion detector is a vibration sensor switch.

3. The article of claim 1, wherein the circuitry further includes an on/off switch.

4. The article of claim 1, wherein the circuitry is a printed circuit board.

5. The article of claim 1, comprising two motion sensors.

6. The article of claim 1, wherein the circuitry further includes a light chip that lights one or more lights when a signal is received from the at least one motion sensor.

7. The article of claim 6, wherein the lights comprise LED or fiber optic lights.

8. The article of claim 1, wherein the sound includes one or more of a wind chime, sounds of nature, or a song.

9. An article comprising:
a flag formed of a natural or synthetic material, and
an inner pocket within the flag, the inner pocket including:
a clock or timer that generates a signal at a certain time or after a certain amount of time;
a speaker;
a battery; and
circuitry that includes a sound chip that plays a sound when the signal is received from the clock or timer.

10. The article of claim 9, wherein the circuitry further includes an on/off switch.

11. The article of claim 9, wherein the circuitry is a printed circuit board.

12. The article of claim 9, wherein the circuitry further includes a light chip that lights one or more lights when a signal is received from the clock or timer.

13. The article of claim 12, wherein the lights comprise LED or fiber optic lights.

14. An article comprising:
a flag formed of a natural or synthetic material, and
an inner pocket within the flag, the inner pocket including:
a Bluetooth receiving device that generates a signal when it receives a signal transmitted by a Bluetooth device;
a speaker;
a battery; and
circuitry that includes a sound chip that plays a sound when the signal is received from the Bluetooth receiving device.

15. The article of claim 14, wherein the Bluetooth receiving device, the speaker, the battery, and the circuitry are located within a waterproof box.
